(19) United States
(12) Patent Application Publication
(10) Pub. No.: US 2011/0290235 A1
(43) Pub. Date: Dec. 1, 2011

(54) EVACUATED SOLAR THERMAL CONDUCTIVE DEVICE

(76) Inventor: Mitchell Jay NewDelman, Thonon-les-Bains (FR)

(21) Appl. No.: 12/791,579

(22) Filed: Jun. 1, 2010

(51) Int. Cl. F24J 2/30; B23P 15/26; F24J 2/04

(52) U.S. Cl. 126/643; 126/646; 29/890.033

(57) ABSTRACT

An evacuated solar thermal conductive device including a conductive heat receiving element having a heat receiving surface and a heat sink portion disposed away from the heat receiving surface. A heat resistant enclosure that includes a top encasing that is at least partially transparent, and a bottom encasing that is joined to the top encasing to create an airtight seal. The bottom encasing having a cavity for receiving at least part of the heat receiving element such that at least part of the heat sink portion is in direct contact with the bottom encasing. A vacuum is provided in a space within the enclosure between at least a part of the heat receiving surface and the top encasing. Solar energy is transmitted to the heat receiving surface through the transparent top encasing and is transferred through the heat receiving element to the heat sink portion.

### BACKGROUND

1. Field

This disclosure relates generally to solar energy, and, more particularly, to a new type of adaptable, efficient and modular solar thermal energy conductive device.

2. Background

Solar thermal energy collectors are a currently viable alternative energy solution. Currently, several major types of solar thermal energy collectors are known, including evacuated tube collectors, flat panel collectors and bulb type collectors.

Bulb type solar collectors (BTC), such as that disclosed in U.S. Pat. No. 4,084,576, utilize a bulb-style housing and a central spire to which sunlight is directed. Pathways are provided for a circulating heat exchanging medium (such as a gas or liquid) to absorb heat. BTCs have not gained widespread acceptance. The use of internal heat exchanging gas and/or fluid pathways make manufacture and use difficult, as extra energy must be provided to pump the gas and/or fluid, and considerations must be taken for possible engineering problems associated with heat conveying gasses and fluids being channeled through small diameter tubing. As a result, BTCs are not adaptable, scalable, nor easy or cheap to manufacture. These shortcomings of BTCs have limited their use and acceptance.

Flat panel or flat plate collectors consist of a simple heat-absorbing “black-box” (sometimes evacuated of air) that collects solar energy as heat and removes the heat using a heat-exchanging pipe or medium (such as a liquid or gas). Similarly, evacuated tube collectors or glass vacuum tubes (GVT) consist of a heat-absorbing medium (usually in the form of a ‘U’ type hollow tube or heat pipe) that is partially or fully inserted within an evacuated transparent glass tube. These collectors are usually installed in arrays where many such tubes are attached to a few heat exchanger manifolds, which utilize a heat exchanging method to carry away useful heat.

Both flat panel collectors and evacuated tube collectors suffer many deficiencies. Evacuated tube collectors are complicated to install and utilize a large amount of space, due to the arrangement of the tubes in the array. Additionally, the total area provided for solar absorption is low relative to the amount of space needed for the array, due to the need to enclose the absorber within a glass tube. Flat panel collectors are similarly cumbersome, and therefore difficult to install. A flat panel collector is typically not evacuated of air, resulting in large heat losses to the cooler ambient environment. Evacuating the flat panel collector to solve this issue is feasible but troublesome, as the flat panel collector uses a metal frame with a standard-sized glass pane position along a top surface (sometimes with a second glass pane on a bottom surface). They therefore require glass-to-metal vacuum seals, which will invariably result in loss of vacuum.

Longevity is also an issue with evacuated tube collectors, as the vacuum integrity of cost-effective tubes is limited by the quality of the materials and components used in its manufacture and the evacuation techniques employed to generate the internal vacuum. As a result, even in the best cases, manufacturers typically guarantee no more than ten years of vacuum integrity unless highly expensive manufacturing materials and/or methods are used. Furthermore, both flat panel and evacuated tube type collectors require secondary considerations with respect to spatial positioning and life cycle. Therefore, their potential for integration into architectural design is practically nonexistent, due to their size and the logistics of their use. Both are difficult to install in or alongside the vertical façade of structures, and neither is aesthetically pleasing.

For these reasons, there is a need for a solar thermal energy conductive device that is adaptable in shape, scalable in size and simple in design to ease manufacture and installation, while retaining and/or improving an acceptable economic efficiency of solar thermal energy collection.

### BRIEF SUMMARY

In one aspect of this disclosure, an evacuated solar thermal conductive device is disclosed. The device comprises a conductive heat receiving element having a heat receiving surface and a heat sink portion disposed away from the heat receiving surface. The evacuated solar thermal conductive device further comprises a heat resistant enclosure that includes a top encasing that is at least partially transparent, and a bottom encasing that is joined to the top encasing to create an airtight seal. The bottom encasing having a cavity for receiving at least part of the heat receiving element such that at least part of the heat sink portion is in direct contact with the bottom encasing. A vacuum is provided in a space within the enclosure between at least a part of the heat receiving surface and the top encasing. Solar energy is transmitted to the heat receiving surface through the transparent top encasing and is transferred through the heat receiving element to the heat sink portion.

In another aspect of this disclosure, a solar thermal conductive system is disclosed. The system comprises a conductive heat receiving element having a heat receiving surface and a heat sink portion disposed away from the heat receiving surface. A heat resistant enclosure that includes a top encasing that is at least partially transparent, and a bottom encasing joined to the top encasing to create an airtight seal. The bottom encasing having a cavity for receiving at least part of the heat receiving element such that at least part of the heat sink portion is in direct contact with the bottom encasing. A vacuum is provided in a space within the enclosure between at least a part of the heat receiving surface and the top encasing. A heat exchanging device is coupled to the bottom encasing. Solar energy is transmitted to the heat receiving surface through the transparent top encasing, transferred through the heat receiving element to the heat sink portion, and transferred from the heat sink portion to the heat exchanging device.

In a third aspect of this disclosure, a method for making an evacuated solar thermal conductive device is disclosed. The method comprises providing a conductive heat receiving element having a heat receiving surface and a heat sink portion disposed away from the heat receiving surface. At least part of the heat receiving element is inserted into a cavity formed in a bottom encasing so that at least part of the heat sink portion is in direct contact with the bottom encasing. The bottom encasing is joined to a top encasing that is at least partially transparent to define a heat resistant enclosure and create an airtight seal. A vacuum is provided in a space within the enclosure between at least a part of the heat receiving surface and the top encasing. Wherein the device is adapted to transmit solar energy to the heat receiving surface through the transparent top encasing and transfer the energy through the heat receiving element to the heat sink portion.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is an exploded cross sectional view of a preferred evacuated solar thermal conductive device;

FIG. 2 is a cross sectional view of the solar thermal conductive device of FIG. 1 installed on a heat exchanging device;

FIG. 3 is a bottom view of an illustrative configuration of heat sink sections protruding from the bottom of the evacuated solar thermal conductive device;

FIG. 4 is a bottom view of an alternate illustrative configuration of heat sink sections protruding from the bottom of the evacuated solar thermal conductive device;

FIG. 5 is a cross sectional view of another preferred embodiment of the evacuated solar thermal conductive device; and

FIG. 6 is a cross sectional view of another preferred embodiment of the evacuated solar thermal conductive device.

### DETAILED DESCRIPTION

This application discloses a new type of solar thermal energy conductive device, which may be referred to as a photonic heat sink (PHS). The PHS preferably includes a heat receiving element (HRE) having an internal heat sink instead of the conventional heat pipe or heat-exchanging medium. The heat sink may be attached to or integrally formed as a single component with the main heat receiving surface of the HRE. The HRE, with its heat sink and heat receiving surface, is preferably enclosed within a housing, which is preferably sealed and at least partially evacuated of air.

The resulting solar thermal conductive device or PHS is advantageous because there is no specific shape or size requirement for any single component of the conductive device. As a result, solar thermal conductive device units may accommodate any range of conditions. For example, the solar thermal conductive device units may be designed small enough so that a single installer could install an entire array of conductive devices with no specialized tools or lifting equipment. Alternatively, the conductive devices may be modified in size, shape, color and/or aperture to serve as a functional and aesthetically pleasing building façade (including artful designs or signage) composed of a plurality of such devices.

The ability to alter the shape of the housing, heat sink and heat receiving element makes the conductive device highly adaptable with respect to both energy production requirements and practical considerations for its installation and spatial usage. The overall shape of the solar thermal energy conductive device or PHS may be modified according to usage requirements. For example, the overall shape may be round, ovular, triangular, rectangular or some other complex or irregular shape. A preferred shape may be square or rectangular (essentially cuboid) with slightly rounded edges for ease of handling. In addition, one of the corners may be indented to allow for easy alignment, placement and removal of the PHS device for maintenance or installation purposes when such devices are installed in an array abutting one another. Alternatively, each edge may terminate in a sharp perpendicular edge so that, when laid side-by-side in an array, the PHS devices would present a generally smooth and flat surface, useful for, for example, an aesthetically pleasing building facade.

The use of a heat sink instead of the more common heat pipe or heat exchanger (such as a fluid or gas) makes the PHS device far simpler to manufacture, increasing cost effectiveness, modularity, and longevity, while reducing complexity. Additionally, the use of a glass-to-glass seal in the outer enclosure also improves the longevity of the internal vacuum, as effective glass-to-glass seals are easy to produce compared to glass-to-metal seals, such as those used in evacuated flat panel type collectors. Finally, the alterability of the shape of the heat receiving element (HRE), in conjunction with the ability to fill a large portion of the housing with the heat receiving element ensures a large ratio of surface area for receiving solar energy (e.g. via the aperture) relative to the space required to install the solar thermal energy conductive device.

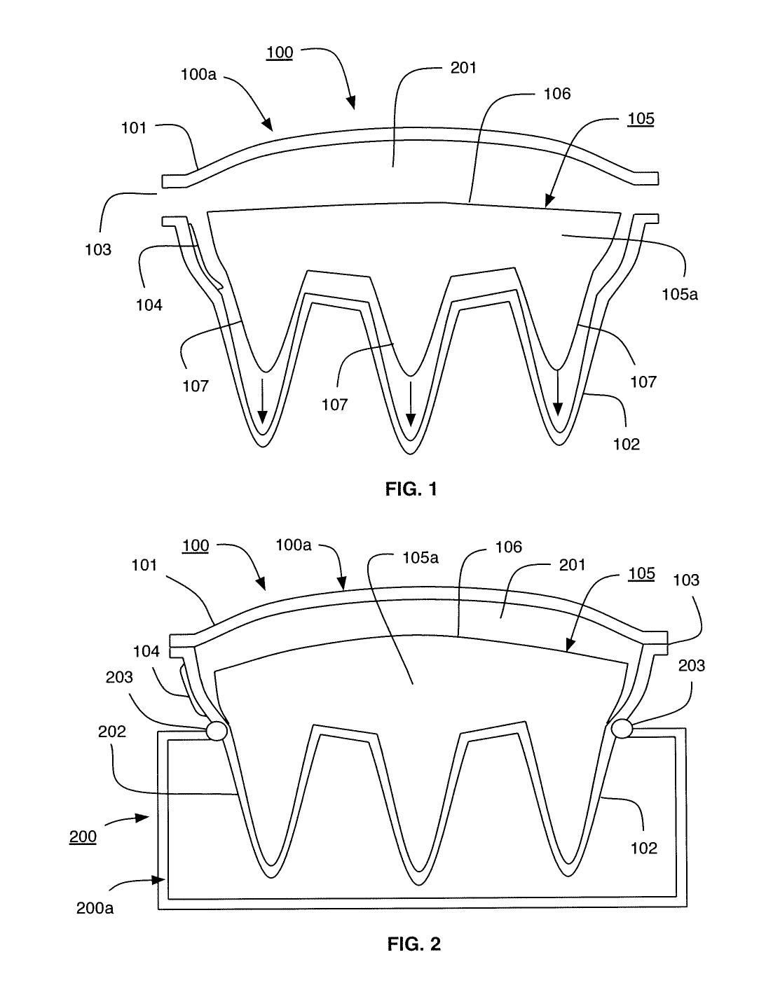

Referring now to the drawings, FIG. 1 illustrates a preferred evacuated solar thermal conductive device or PHS 100. The device 100 preferably includes an enclosure 100a formed from a top hemisphere encasing 101 and a bottom hemisphere encasing 102. The top hemisphere encasing 101 preferably has a dome-like shape, with the slope of the dome falling off at a gradient as it tapers down to the edge. This configuration may be advantageous for allowing sunlight into the enclosure 100a from a wide range of angles and at various latitudes north or south of the equator, which may be useful if the solar thermal conductive device 100 is to remain static while the sun traverses the sky over the course of the day (as a result of the earth's rotation). Top hemisphere encasing 101 may be formed of any translucent high heat-resistant glass or glass-like material. The glass may be, for example, completely clear, or colored for aesthetic purposes. Pyrex™ is a commercially available transparent and heat-resistant material, which may be used to form top hemisphere encasing 101. Alternatively, thick tempered glass (such as the glass utilized in older sealed-beam headlamps) may be utilized, as it has high resistance to incidental and/or weather damage (e.g., rocks and hail). The material is preferably selected to withstand both the external and internal environmental conditions to which the solar thermal energy conductive device 100 will be subjected.

Bottom hemisphere encasing 102 may also be formed of any glass or glass-like material, and may be opaque or translucent according to the needs of the end user. Bottom hemisphere encasing 102 may also include an optional reflective coating 104, which preferably extends around at least part of the interior circumference of the bottom hemisphere encasing 102 (as depicted in FIG. 1) to redirect additional solar light towards an encapsulated heat receiving element (HRE) 105. Alternatively, the reflective coating 104 may be installed around at least part of an external circumference of the bottom hemisphere encasing 102 (as depicted in FIG. 2). The reflective coating 104 is preferably made of any suitable reflective material with the ability to withstand the environmental conditions within or without the enclosure 100.

The heat receiving element 105 forms the core of the solar thermal conductive device 100. The heat receiving element 105 preferably includes a heat receiving surface 106 and one or more heat sinks 107. The heat receiving surface 106 and one or more heat sinks 107 may be integrally formed as part of a the heat receiving element 105, or they may be separate pieces joined together in a conventional manner, such as, for example, bonding, fastening, welding, soldering, cladding, etc. Solar energy, in the form of light, may strike the heat receiving surface 106, heating the heat receiving surface 106. This absorbed heat is transmitted by conduction in a direction toward the one or more heat sinks 107.

The heat receiving element 105 is preferably made of one or more conductive materials, such as (but not limited to) copper, iron, steel or aluminum. A combination or alloy of such materials may also be used, if desired. Other materials may also be utilized according to usage requirements. For example, weight restrictions, cost, materials availability and other considerations may limit the possible materials with which to create the heat receiving element 105. New or currently undiscovered exotic and/or non-traditional conductive materials (such as, for example, graphene on a metal substrate and unidirectional conductive polymers) are also contemplated, and may be utilized to make the heat receiving element 105 as technology and understanding advances. Additionally, heat sinks 107 are preferably shaped according to end user requirements, and may be of any configuration, such as (but not limited to) fingers, protrusions, fins, flanges, etc. as appropriate to maximize, for example, spatial utility or conduction, convection and/or thermal radiation in the selected heat exchanger. In the preferred embodiment, heat sinks 107 preferably protrude away from the main body 105a of the heat receiving element 105.

The heat receiving element 105 may be colored via an external coating or a material selected to form the body of the heat receiving element 105 (or some combination thereof). Alternatively, the top hemisphere encasing 101 may be tinted or otherwise colored. In this manner, an array of PHS devices 100 with one or more colors may then be installed on a façade in an arrangement, creating an aesthetically pleasing colored façade, visual image, pattern, etc. While black is clearly a preferred color in terms of maximizing the amount of absorbed light (and therefore heat), other hues, such as (but not limited to) red, green, blue, etc. may also be utilized in conjunction with an acceptable reduction in heat absorbing efficiency, balancing a need to be aesthetically pleasing while remaining practical as an energy collecting array of PHS devices.

Positioning the point of heat transfer (i.e., the portion of the heat sink 107 in contact (direct or indirect) with a heat exchanger) away from the main body 105a of the solar thermal energy conductive device 100 may be advantageous as it forces heat to travel away from the main body 105a in a direction towards the heat sink 107. Additionally, the preferred PHS design eliminates many serious impediments associated with current solar technologies utilizing an internally circulating liquid or gas heat exchanger medium confined in a small diameter tube or conduit. Because the solar thermal energy conductive device 100 does not need to account for impediments caused by the use of an internally circulating liquid or gas (such as changing mechanical pressure), engineering and manufacturing the solar thermal energy conductive device 100 is simplified over preexisting devices. As a result, the solar thermal energy conductive device 100 is highly scalable, both in shape, color and usage.

The heat receiving element (HRE) 105, like the enclosure 100a, may be shaped according to the needs of the end user. The heat receiving surface 106 of HRE 105 is preferably configured to maximize the surface area available for receiving solar energy. For this reason, the heat receiving surface 106 may be configured to take up the maximum amount of space available in the lower hemisphere encasing 102, or the lower hemisphere encasing 102 may be molded to conform to the final shape of the heat receiving element 105, as depicted in the illustrative embodiment of FIG. 2. Preferably, the top outer edge of the heat receiving element 105 does not extend laterally beyond the top perimeter of the bottom hemisphere encasing 102 to avoid difficulty during manufacturing, particularly with respect to the creation of vacuum 201 (described below) within the interior of enclosure 100a.

Once both components are formed, heat receiving element 105 may be inserted or pressed into the bottom hemisphere encasing 102 during assembly of the PHS device 100. Alternatively, heat receiving element 105 may be inserted or pressed into a molten, still pliant bottom hemisphere encasing 102 (if the materials and manufacturing logistics allow), causing the bottom hemisphere encasing 102 to conform to the shape of the heat receiving element 105 and create an even greater airtight fit between the heat receiving element 105 and the bottom hemisphere encasing 102. In either case, insertion of heat receiving element 105 preferably leaves no space between the heat receiving element 105 and the internal surface of the bottom hemisphere encasing 102.

Top hemisphere encasing 101 and bottom hemisphere encasing 102 may be joined or fused together to define a seam 103, which preferably extends around the entire circumference of both top hemisphere encasing 101 and bottom hemisphere encasing 102 to form an airtight seal. As mentioned earlier, top hemisphere encasing 101 and bottom hemisphere encasing 102 may have any desired shape. However, it is preferable that their perimeters along the edge of seam 103 be similarly shaped (if not identical) to ease the process of sealing the enclosure 100a. Sealing may be accomplished according to conventional techniques known in the art, dependent on the material (or materials) selected to create top hemisphere encasing 101 and bottom hemisphere encasing 102. Seam 103 is preferably strong enough to hold and support an evacuated vacuum 201 within the interior of enclosure 100a. Vacuum 201 preferably encompasses at least the entirety of the heat receiving surface 106. As mentioned above, by enclosing the entirety of the heat receiving surface 106 within vacuum 201, heat dissipation to the cooler ambient environment outside the top hemisphere encasing 101 is substantially reduced. Any type of vacuum generating device or method may be utilized to create vacuum 201 within the interior of the enclosure 100a. For example, a “gettering” type vacuum pump may be utilized, as it may achieve a considerably longer vacuum life span relative to other vacuum generating processes (such as the vacuum generated in a sealed, enclosed space by mechanical pump).

Alternative forms of the heat receiving element 105 are also contemplated, including hollow elements filled with components that enhance certain characteristics of the heat receiving element 105. For example, the heat receiving element 105 may be hollow and filled with a gas, liquid, polymer or even thermoplastic plasma (or some combination of the above) to enhance conductivity and/or reduce weight. Alternatively, openings may be formed in the sections of the hollow heat receiving element 105 that are in contact with the vacuum region 201 of the enclosure 100a, which preferably reduces the weight of the PHS device 100 without impeding the overall heat conductivity of the device.

In another alternative embodiment, the heat receiving element (HRE) 105 is formed with a mushroom-like shape. The dome/cap of the HRE 105 receives and absorbs sunlight, and transmits heat energy via conduction in a direction toward the stem-like heat sink of the HRE, which passes the heat energy on to a heat exchanger for recovery of energy (in a manner similar to the embodiment depicted in FIG. 6). No specific form is required, as the physical shape and configuration of the disclosed solar thermal energy conductive device 100 is intended to be flexible to accommodate a wide variety of needs and uses.

The heat receiving element 105 may also be coated with a coating that aids heat absorption. One particularly advantageous coating may be niobium (Nb), which has excellent solar thermal heat absorption qualities. Other rare absorption metals (or metal alloys) may be also be used as desired, such as (but not limited to) titanium (Ti), zirconium (Zr), hafnium (Hf), scandium (Sc), yttrium (Y), lanthanum (La), barium (Ba), vanadium (V), tantalum (Ta), thorium (Th), etc.

FIG. 2 illustrates the assembled solar thermal conductive device or PHS 100 installed in a heat exchanging device 200. The solar thermal energy conductive device 100 may be used with (or adapted to be used with) many possible forms of heat exchanging devices 200, including heat manifolds or other similar heat transport devices (such as, for example, a device known as a “header”) that can be used to store or transport the solar thermal heat collected by the PHS device 100. Preferably, the heat exchanging device 200 and solar thermal energy conductive device 100 can be mated or otherwise coupled directly to one another. In the preferred embodiment illustrated in FIG. 2, the lower portion (including heat sinks 107) of the solar thermal energy conductive device 100 is preferably inserted or pressed into a prefabricated slot or groove 202 formed in the heat exchanging device 200 to thereby form a tight fit between heat exchanging device 200 and the solar thermal energy conductive device 100. The solar thermal energy conductive device 100 may be secured to the heat exchanging device 200 utilizing any suitable known technique or mechanism 203, such as (but not limited to) the use of pressure clips, O-rings, clamps, screw-downs and other conventional locking mechanisms. Mechanism 203 may complement or, preferably, double as an air and water tight seal to prevent contamination of the contact surface 202 or interior of the heat exchanging device 200. The external walls of heat exchanging device 200 are also preferably insulated with insulating layer 200a in a conventional manner to better retain heat and minimize heat loss while transferring the collected heat away from the PHS device 100. For example, layer 200a may constitute a small outer insulating casing, wrapping or coating that covers the exposed surfaces of heat exchanging device 200.

Heat exchanging devices 200 may take the form, for example, of a specially designed and engineered sun-facing wall of a building façade, where the wall itself holds PHS devices 100. PHS devices 100 may be fitted/installed from either side, but all preferably protrude to its exterior to allow light to reach the heat receiving elements 105. Heat sinks 107 preferably protrude into the interior of the wall for insertion into a heat-exchanging manifold that is affixed to or built into the interior side of the wall. Alternatively, the heat-exchanging manifold may comprise the wall itself, wherein an outer wall and inner wall encapsulate a space for collecting heat. The space may include a heat-exchanging medium (such as, for example, a fluid, gas, etc.) for carrying the collected heat, which may be used for heating and/or cooling the building, or for generating electricity by venting the collected heat through a turbine.

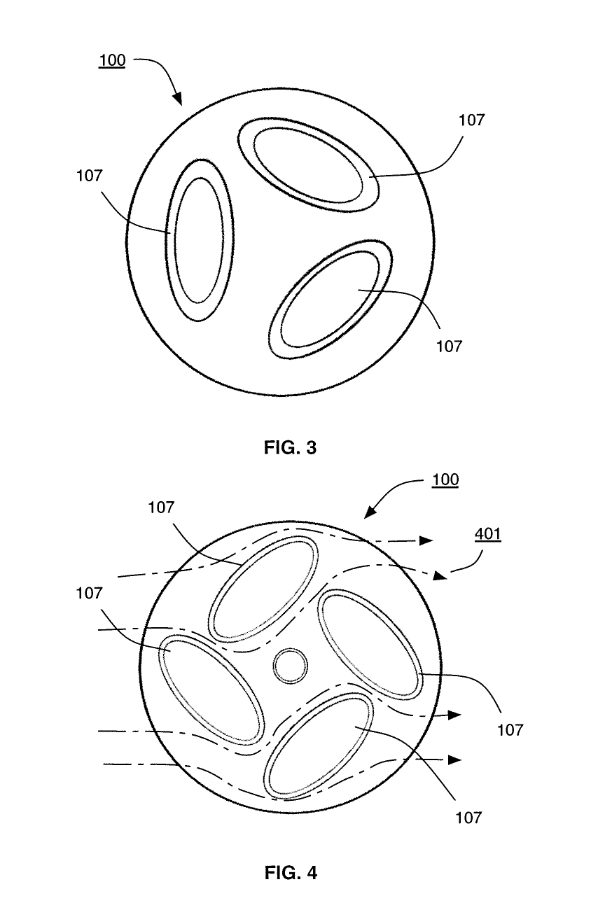

FIGS. 3 and 4 are bottom perspective views of two illustrative configurations of heat sinks 107. In the two illustrative configurations, heat sinks 107 (and the accompanying portion of the bottom hemisphere encasing 102) extend down and away from the main body 105a of the HRE 105 of the solar thermal energy conductive device 100. Such a configuration is preferable when the solar thermal energy conductive device 100 is to be installed into a heat exchanging device for heat exchange, wherein the heat sinks 107 must protrude away from the body of the PHS device to make contact with a heat exchanger medium (such as a gas or liquid).

In FIG. 4, flow lines 401 illustrate possible avenues of fluid or gas flow around heat sinks 107 after the solar thermal energy conductive device has been installed in a heat-exchanging device. The heat sinks 107 may be positioned as to encounter the heat exchanger medium and force the medium to move around the heat sinks 107 (as represented by flow lines 401). This preferably lengthens the contact duration between heat sinks 107 and the heat exchanger medium and may, therefore, increase the amount of heat removed to the exchanger per cycle. As stated earlier, any configuration of heat sinks 107 may be implemented as desired or necessary, as the PHS 100 allows for unique modularity in terms of shape, size and scale.

It should be noted, however, that thermal shock may damage the solar thermal energy conductive device 100 (or its components) if, for example, it is suddenly exposed to low temperature heat exchanging fluid or gas after having reached a sufficiently high temperature. Therefore, measures should preferably be taken to avoid damaging thermal shock, such as (but not limited to) venting of excess heat or, preferably, maintaining constant contact between the solar thermal energy conductive device 100 and the heat exchanging medium to minimize the temperature differential between them.

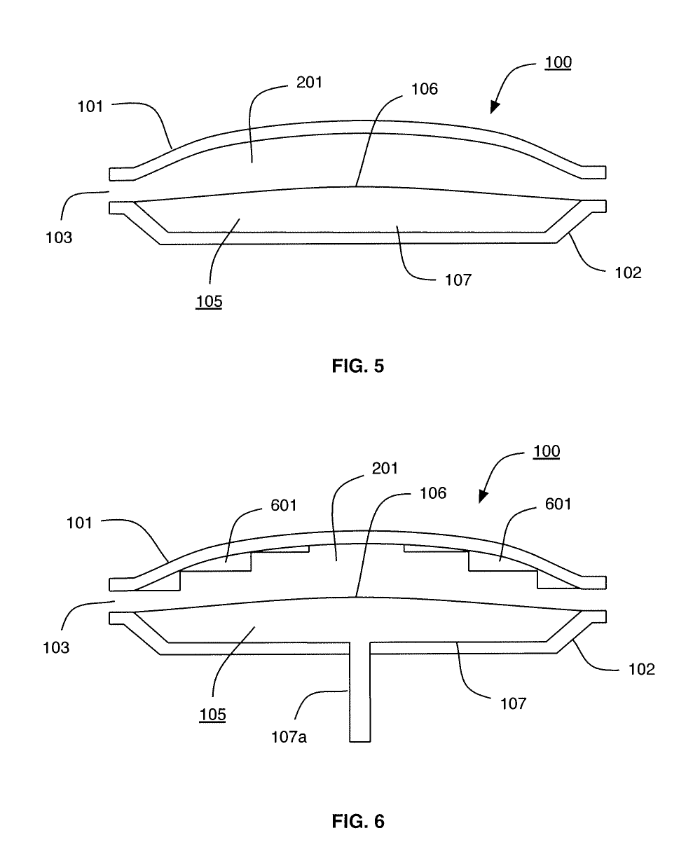

FIG. 5 illustrates another embodiment of the evacuated solar thermal conductive device or PHS 100. Like the embodiment illustrated in FIGS. 1-2, the PHS device 100 illustrated in FIG. 5 includes a top hemisphere encasing 101 and bottom hemisphere encasing 102, seam 103 and heat receiving element 105. However, unlike the previous embodiment, heat sink 107 preferably does not extend or project from the evacuated solar thermal conductive device 100. Instead, heat sink 107 may have a generally flat bottom surface. This configuration may be advantageous for connection to a heat receiving manifold designed to accommodate a shallow insertion of the solar thermal conductive device 100. Heat exchange would occur as heat exchanging fluid or gas passes along (and thereby contacts) the flat bottom of the solar thermal conductive device 100. However, vacuum 201 persists around the heat receiving surface 106 to prevent unwanted heat loss to the cooler ambient environment.

FIG. 6 illustrates another embodiment of the evacuated solar thermal energy conductive device or PHS 100, which may be advantageous for a user who desires the heat sink 107 to make direct contact with a heat exchanging medium. Like the other embodiments, the PHS device 100 includes a top hemisphere encasing 101 and bottom hemisphere encasing 102, seam 103 and heat receiving element 105. Vacuum 201 persists around the heat receiving surface 106 of the HRE 105 in the assembled PHS device 100 to prevent unwanted heat loss to the cooler ambient environment. However, heat sink 107 preferably includes a heat sink protrusion 107a, which extends beyond the bottom hemisphere encasing 102. The protrusion 107a may make direct contact with a heat exchanging medium when the solar thermal energy conductive device 100 is installed in a heat exchanging device. It is understood that the protrusion 107a as shown is illustrative. The protrusion 107a may take the form of any shape, size and penetrative depth required. For example, the protrusion 107a may be designed to help support or attach the PHS device 100 to or through a building wall/façade, or directly into a heat exchanging manifold, thereby reducing the mechanical load on the PHS device, or even eliminating the need for a separate means of attachment.

Additional considerations may need to be taken to maintain the internal integrity of this alternative embodiment of the solar thermal energy conductive device 100 illustrated in FIG. 6. For example, the vacuum 201 is ideally maintained by the extremely tight fit between the bottom of heat receiving element 105 (including protrusion 107a) and the internal surface of bottom hemisphere encasing 102. However, additional sealing/bonding may be required between bottom hemisphere encasing 102 and the base of protrusion 107a to maintain the air and water tight seal within the enclosure 100a. The shape of the PHS device 100 may be selected to enable a superior vacuum seal/bond between the bottom hemisphere encasing 102 and the protrusion 107a by maximizing the contact area between the bottom hemisphere encasing 102 and the receiving heat element 105 (as depicted in FIG. 6). The increased contact area available for creating the seal may provide a more long lasting or even quasi-permanent bond/seal relative to the bond/seal on a conventional evacuated flat panel collector. Additionally, a layer of material with diminished heat conduction properties may be interposed between the heat receiving element 105 and bottom hemisphere encasing 102 to further reduce the amount of heat that reaches the seal, thereby increasing the efficiency of the device.

Also depicted in FIG. 6 is an optional optical enhancer 601 formed on the top hemisphere encasing 101, which may serve to enhance the quantity or quality of light (via, for example, focusing) of sunlight striking the heat receiving surface 106 of HRE 105. Optical enhancer 601 may be implemented, for example, by a special material coating, specialized shaping of the top hemisphere encasing 101, texturing of the internal surface of top hemisphere encasing 101, fluting, magnification and/or focusing lens shapes, etc.

In an alternative embodiment, the PHS device 100 may be utilized to implement a “solar chimney,” in which heat collected by way of a PHS device 100 (or an array of such devices) is vented to create electrical energy. When collected solar heat is not required and/or desired for use, excess heat may be collected and vented/redirected into a chimney style vent (using known chimney drafting techniques). The rising hot air may then drive a turbine located at or near the top of the vent to produce electricity. The vent structure may be affixed to or constitute part of a larger structure in which the PHS device(s) 100 is installed, such as a building. This configuration is advantageous because it allows one to control the operating temperature of the PHS device 100 (or an array of such devices) by allowing the venting of excess heat. Additionally, vented excess heat may be partially recaptured for use as electricity, supplementing and/or complementing the heat collecting function of the PHS device 100.

In an alternative embodiment, the top hemisphere encasing 101 may be bonded/sealed directly to heat receiving element 105, with the space between these elements defining an evacuated vacuum region. The efficacy of this embodiment is dependent upon the quality of the glass-to-metal seal.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed

What is claimed is:

1. An evacuated solar thermal conductive device, comprising:
a conductive heat receiving element having a heat receiving surface and a heat sink portion disposed away from the heat receiving surface; and
a heat resistant enclosure that includes a top encasing that is at least partially transparent, and a bottom encasing joined to the top encasing to create an airtight seal, the bottom encasing having a cavity for receiving at least part of the heat receiving element such that at least part of the heat sink portion is in direct contact with the bottom encasing;
wherein a vacuum is provided in a space within the enclosure between at least a part of the heat receiving surface and the top encasing, and solar energy is transmitted to the heat receiving surface through the transparent top encasing and is transferred through the heat receiving element to the heat sink portion.

2. The solar thermal conductive device of claim 1, wherein the heat receiving element does not contact the top encasing.

3. The solar thermal conductive device of claim 1, wherein at least an internal portion of the bottom encasing has a reflective coating.

4. The solar thermal conductive device of claim 1, wherein the top and bottom encasings are made of heat resistant glass.

5. The solar thermal conductive device of claim 1, wherein the heat sink portion is completely contained within the enclosure.

6. The solar thermal conduct device of claim 5, wherein the cavity in the bottom encasing is configured to conform to a shape of the heat sink portion so that the heat sink portion fits tightly within the cavity.

7. The solar thermal conductive device of claim 1, wherein the heat sink portion is at least partially exposed outside the enclosure to allow direct contact between the heat sink portion and a heat exchanging device.

8. The solar thermal conductive device of claim 1, wherein the heat sink portion includes a plurality of heat sinks projecting away from the heat receiving surface.

9. The solar thermal conductive device of claim 8, wherein the bottom encasing includes a plurality of cavities, each cavity receiving one of the plurality of heat sinks and conforming to a shape of the received heat sink to provide for a tight fit between the received heat sink and the cavity.

10. The solar thermal conductive device of claim 1, wherein the vacuum is generated by a gettering type vacuum pump.

11. The solar thermal conductive device of claim 1, wherein the heat receiving element is at least partially coated with a heat absorption material.

12. The solar thermal conductive device of claim 11, wherein the heat absorption material comprises niobium.

13. The solar thermal conductive device of claim 11, wherein the heat absorption material is selected from the group consisting of titanium, zirconium, hafnium, scandium, yttrium, lanthanum, barium, vanadium, tantalum and thorium.

14. The solar thermal conductive device of claim 1, wherein the heat receiving element is formed from a conductive material selected from the group consisting of copper, iron, steel and aluminum.

15. The solar thermal conductive device of claim 1, wherein the solar thermal conductive device is coupled to a heat exchanging device.

16. The solar thermal conductive device of claim 1, wherein the heat receiving element is hollow.

17. The solar thermal conductive device of claim 16, wherein the hollow heat receiving element contains a conductivity enhancing material.

18. The solar thermal conductive device of claim 17, wherein the conductivity enhancing material is selected from the group consisting of a gas, liquid, polymer and thermoplastic plasma.

19. The solar thermal conductive device of claim 16, wherein hollow portions of the hollow heat receiving element are in contact with the vacuum.

20. The solar thermal conductive device of claim 1, wherein the heat receiving element is coated with a material to achieve a desired color.

21. The solar thermal conductive device of claim 20, wherein the material is niobium.

22. The solar thermal conductive device of claim 1, wherein the heat receiving element is formed of a material to achieve a desired color.

23. The solar thermal conductive device of claim 1, wherein the solar thermal conductive device is installed in a sun-facing façade of a structure.

24. A solar thermal conductive system, comprising:
a conductive heat receiving element having a heat receiving surface and a heat sink portion disposed away from the heat receiving surface;
a heat resistant enclosure that includes a top encasing that is at least partially transparent, and a bottom encasing joined to the top encasing to create an airtight seal, the bottom encasing having a cavity for receiving at least part of the heat receiving element such that at least part of the heat sink portion is in direct contact with the bottom encasing, wherein a vacuum is provided in a space within the enclosure between at least a part of the heat receiving surface and the top encasing; and
a heat exchanging device coupled to the bottom encasing;
wherein solar energy is transmitted to the heat receiving surface through the transparent top encasing, transferred through the heat receiving element to the heat sink portion, and transferred from the heat sink portion to the heat exchanging device.

25. The solar thermal conductive system of claim 24, wherein the heat receiving element does not contact the top encasing.

26. The solar thermal conductive system of claim 24, wherein at least an internal portion of the bottom encasing has a reflective coating.

27. The solar thermal conductive system of claim 24, wherein the top and bottom encasings are made of heat resistant glass.

28. The solar thermal conductive system of claim 24, wherein the heat sink portion is completely contained within the enclosure.

29. The solar thermal conductive system of claim 28, wherein the cavity in the bottom encasing is configured to conform to a shape of the heat sink portion so that the heat sink portion fits tightly within the cavity.

30. The solar thermal conductive system of claim 24, wherein the heat sink portion is at least partially exposed outside the enclosure to allow direct contact between the heat sink portion and the heat exchanging device.

31. The solar thermal conductive device of claim 24, wherein the heat sink portion includes a plurality of heat sinks projecting away from the heat receiving surface.

32. The solar thermal conductive system of claim 31, wherein the bottom encasing includes a plurality of cavities, each cavity receiving one of the plurality of heat sinks and conforming to a shape of the received heat sink to provide for a tight fit between the received heat sink and the cavity.

33. The solar thermal conductive system of claim 24, wherein the vacuum is generated by a gettering type vacuum pump.

34. The solar thermal conductive system of claim 24, wherein the heat receiving element is at least partially coated with a heat absorption material.

35. The solar thermal conductive system of claim 34, wherein the heat absorption material comprises niobium.

36. The solar thermal conductive system of claim 34, wherein the heat absorption material is selected from the group consisting of titanium, zirconium, hafnium, scandium, yttrium, lanthanum, barium, vanadium, tantalum and thorium.

37. The solar thermal conductive system of claim 24, wherein the heat receiving element is formed from a conductive material selected from the group consisting of copper, iron, steel and aluminum.

38. The solar thermal conductive system of claim 24, wherein the heat receiving element is hollow.

39. The solar thermal conductive system of claim 38, wherein the hollow heat receiving element contains a conductivity enhancing material.

40. The solar thermal conductive system of claim 39, wherein the conductivity enhancing material is selected from the group consisting of a gas, liquid, polymer and thermoplastic plasma.

41. The solar thermal conductive system of claim 38, wherein hollow portions of the hollow heat receiving element are in contact with the vacuum.

42. The solar thermal conductive system of claim 24, wherein the heat receiving element is coated with a material to achieve a desired color.

43. The solar thermal conductive system of claim 42, wherein the material is niobium.

44. The solar thermal conductive system of claim 24, wherein the heat receiving element is formed of a material to achieve a desired color.

45. The solar thermal conductive system of claim 24, wherein the heat exchanging device is installed in a sun-facing façade of a structure.

46. A method for making an evacuated solar thermal conductive device, comprising:
providing a conductive heat receiving element having a heat receiving surface and a heat sink portion disposed away from the heat receiving surface;
inserting at least part of the heat receiving element into a cavity formed in a bottom encasing so that at least part of the heat sink portion is in direct contact with the bottom encasing;
joining the bottom encasing to a top encasing that is at least partially transparent to define a heat resistant enclosure and create an airtight seal;
providing a vacuum in a space within the enclosure between at least a part of the heat receiving surface and the top encasing;
wherein the device is adapted to transmit solar energy to the heat receiving surface through the transparent top encasing and transfer the energy through the heat receiving element to the heat sink portion.

47. The method of claim 46, wherein the heat receiving element does not contact the top encasing.

48. The method of claim 46, further comprising coating at least an internal portion of the bottom encasing with a reflective coating.

49. The method of claim 46, wherein the top and bottom encasings are made of heat resistant glass.

50. The method of claim 46, wherein the heat sink portion is completely contained within the enclosure.

51. The method of claim 50, wherein the cavity in the bottom encasing is configured to conform to a shape of the heat sink portion so that the heat sink portion fits tightly within the cavity.

52. The method of claim 46, wherein the heat sink portion is at least partially exposed outside the enclosure to allow direct contact between the heat sink portion and a heat exchanging device.

53. The method of claim 46, wherein the heat sink portion includes a plurality of heat sinks projecting away from the heat receiving surface.

54. The method of claim 53, wherein the bottom encasing includes a plurality of cavities, each cavity receiving one of the plurality of heat sinks and conforming to a shape of the received heat sink to provide for a tight fit between the received heat sink and the cavity.

55. The method of claim 46, wherein the vacuum is generated by a gettering type vacuum pump.

56. The method of claim 46, further comprising at least partially coating the heat receiving element with a heat absorption material.

57. The method of claim 56, wherein the heat absorption material comprises niobium.

58. The method of claim 56, wherein the heat absorption material is selected from the group consisting of titanium, zirconium, hafnium, scandium, yttrium, lanthanum, barium, vanadium, tantalum and thorium.

59. The method of claim 46, wherein the heat receiving element is formed from a conductive material selected from the group consisting of copper, iron, steel and aluminum.

60. The method of claim 46, further comprising coupling the solar thermal conductive device to a heat-exchanging device.

61. The method of claim 46, wherein the heat receiving element is hollow.

62. The method of claim 61, wherein the hollow heat receiving element contains a conductivity enhancing material.

63. The method of claim 62, wherein the conductivity enhancing material is selected from the group consisting of a gas, liquid, polymer or thermoplastic plasma.

64. The method of claim 61, wherein hollow portions of the hollow heat receiving element are in contact with the vacuum.

65. The method of claim 46, wherein the heat receiving element is coated with a material to achieve a desired color.

66. The method of claim 65, wherein the material is niobium.

67. The method of claim 46, wherein the heat receiving element is formed of a material to achieve a desired color.

68. The method of claim 46, wherein the solar thermal conductive device is installed in a sun-facing façade of a structure.

69. A solar thermal conductive device, comprising:
an enclosure that is at least partially transparent; and
a heat receiving element that includes a heat receiving section and a heat sink section;
wherein the heat receiving section is enclosed within a vacuum and at least partially bonded to the enclosure, and the heat sink section is exposed.
